(19) United States
(12) Patent Application Publication
(10) Pub. No.: US 2023/0249944 A1
(43) Pub. Date: Aug. 10, 2023

(54) IMPROVEMENTS IN OR RELATING TO STAIRLIFTS

(71) Applicant: STANNAH STAIRLIFTS LIMITED, Andover Hampshire (GB)

(72) Inventors: Max Daniel Woodhams, Andover Hampshire (GB); Andreas Csaba Szentistvany, Ragged Appleshaw Hampshire (GB)

(21) Appl. No.: 18/013,490

(22) PCT Filed: Jun. 29, 2021
(86) PCT No.: PCT/GB2021/051635

§ 371 Date: Dec. 28, 2022

(30) Foreign Application Priority Data
Jun. 30, 2020 (GB) 2010021.0

(51) Int. Cl. B66B 9/08

(52) U.S. Cl. CPC B66B 9/0815; B66B 9/0846

(57) ABSTRACT

A friction drive stairlift has a pair of drive wheels in frictional engagement with an upper surface of a stairlift rail. The drive wheels are mounted to rotate in a vertical plane passing through the centreline of the stairlift rail. The rail is preferably formed from two substantially parallel tubes and the carriage is maintained perpendicular to that part of the rail with which it is in contact at any particular time.

### CROSS-REFERENCE TO RELATED APPLICATIONS

This application is the U.S. National Stage of PCT/GB2021/051635 filed on Jun. 29, 2021, which claims priority to United Kingdom Patent Application 2010021.0 filed on Jun. 30, 2020, the entire content of both are incorporated herein by reference in their entirety.

### FIELD OF THE INVENTION

This invention relates to stairlifts and, in particular, though not necessarily exclusively, to a stairlift in which the stairlift rail includes changes in inclination and/or direction. Such a stairlift is commonly referred to as a curved stairlift and is contrasted with a straight stairlift in which the rail is at a single, fixed, angle of inclination.

### BACKGROUND TO THE INVENTION

Numerous forms of curved stairlift are available today which address the needs and wishes of users in a variety of ways. In general there is an increasing demand not only for functionality but also in ease of manufacture, installation and maintenance; and also for factors such as ride quality and aesthetics. Desirably a section of the stairlift rail, at the lower end of the rail, should be vertical to allow the carriage to travel down to a position in which the footrest is positioned close to floor level for safe mounting on, and dismounting from, the stairlift. It is further desirable that bends in the rail have tight horizontal bends so that the intrusion of the rail into the stairway is minimised.

The majority of stairlifts currently available include a rack and pinion drive arrangement. Such a drive arrangement is robust and reliable but certain limitations arise from its use. For example, rail sections must be provided in lengths that are multiples of the tooth pitch of the rack, and it is not always possible to accurately match the pitch when joining rail sections together. As a consequence ride quality, which in any event is not optimum in rack and pinion drives, suffers; and the problem increases with increasing carriage speed. Given the desire to maintain stairlift speed as close as possible to the allowable 0.15 m/sec maximum, the ride quality problem is a significant drawback with rack and pinion drives. Further, there are limitations in bend radii that can be accommodated because the tooth pitch and/or alignment changes in bends and may do so to an extent that causes meshing problems with the drive pinion.

Friction drive has been proposed as an alternative to rack and pinion drive. U.S. Pat. No. 2,888,099 describes a friction drive stairlift in which multiple drive wheels on a common drive axis are biased into contact with the top plate of an angle-sectioned rail. Relative rotation between the chair and the carriage, in order to maintain the carriage axis vertical, and the chair level as it passes through transition bends, is effected by a mechanical linkage acting on a levelling bar fixed to, and extending along the rail, below the top plate of the rail. This limits the steepness of rail angle that can be achieved and, while it is disclosed within the body of the patent that the described stairlift could be configured to include bends in a horizontal plane (also called inside/outside bends), this bend type is not depicted or described and, because of the rail section and the broad width of the drive wheel, any horizontal bend would necessarily be of such a large radius as to make the stairlift impractical for fitment to the staircase of a domestic dwelling.

Another form of friction drive stairlift is described in British Patent GB 2 379 209 granted to the present applicant. In this patent the rail is formed by two vertically spaced tubes with the stairlift carriage being slidably mounted on the upper tube by what is commonly referred to as a skate. The carriage further includes a support roller which bears against the lower tube to prevent the carriage and chair assembly from pitching forward or rotating about the lengthwise directional axis of the rail. Since the carriage remains vertical at all times, there is a limitation on the rail angle that can be accommodated since, at steeper rail angles, the lower support roller has lessening contact with the bottom rail tube, and a rail configuration such as that described in published International Patent Applications WO 2005/085114 and WO 2017/187161 could not be realised as the bottom support roller would be completely out of contact with the lower rail tube. A further problem with the stairlift described in this patent is that, in inside/outside bends, the drive roller scrubs laterally across the surface of the upper tube which gives rise to increased wear.

A further configuration of friction drive stairlift is described in published International Patent Application WO 2014/098573. A rail is provided having a cross-section in the form of a cylinder or oval in which opposed sides are formed inwardly into laterally facing recesses which extend the length of the rail. Drive wheels are located in the recesses. The described arrangement is believed to have a number of limitations. Firstly, the rail is of a cross-sectional shape that is difficult to form and, in particular, difficult to form so that the cross-sectional shape is maintained in bends. Another problem is that because the drive wheels engage in the recesses in the lateral surfaces of the rail, the carriage must have sufficient width to accommodate the drive. The drive itself limits the radius of inside/outside bends that can be achieved and the lateral bulk of the arrangement limits the rail-to-wall dimension that can be achieved. Finally, the drive wheels must not only provide the frictional forces to drive the carriage along the rail, but must also react the loads tending to cause the carriage to pitch or roll about the rail axis. As a result, the drive wheels would be expected to experience considerable wear.

It is an object of the invention to provide a friction drive stairlift which will go at least some way in addressing the aforementioned problems; or which will at least provide a novel and useful choice.

### SUMMARY OF THE INVENTION

Accordingly, in a first aspect, the invention provides a stairlift including a rail having a top surface and a length direction axis extending parallel to said top surface; a carriage mounted on said rail for movement there-along, said carriage and said rail being configured such that the carriage is substantially perpendicular to the length direction axis at any position of the carriage on the rail; and a chair mounted on said carriage, wherein said top surface defines a drive surface extending along said rail, said carriage including a plurality of

drive rollers configured and arranged to frictionally engage said drive surface at spaced positions on said drive surface, a reference plane passing through the centre of each drive roller, perpendicular to the axis of rotation of the respective drive roller, passing through a centreline of the rail at any position of the carriage on the rail, said carriage further including biasing means to bias said drive rollers against said drive surface; and means to resist rotational movement of said carriage about said length direction axis.

Preferably said drive surface is defined by a first lengthwise extending member and said means to resist rotational movement of said carriage about said length direction axis is defined in part by a second lengthwise extending reaction surface and wherein, when said rail is in its position of use, said reaction surface is spaced from and below said drive surface.

Preferably said first and second lengthwise extending members comprise two substantially evenly spaced tubes of round cross section which, when the rail is mounted for use, are arranged substantially one above one the other.

Preferably the drive rollers engage an upper tube of said two spaced tubes, said biasing means including one or more biasing rollers engaging an underside of said upper tube.

Alternatively the drive rollers engage an upper tube of said two spaced tubes, said biasing means including one or more biasing rollers engaging a lower tube of said two spaced tubes.

Preferably said biasing rollers partly define said means to resist rotation of the carriage about said length direction axis.

Preferably said means to resist rotational movement of said carriage about said length direction axis includes a plurality of support rollers engaging a lower tube of said two spaced tubes.

Preferably said plurality of support rollers comprise two rollers engaging said lower tube on opposite sides of a vertical centreline of said lower tube.

Preferably said two rollers comprise a first roller rotatable about a fixed axis; and a second roller rotatably mounted on an arm, the arm being mounted to pivot about said fixed axis.

Preferably said biasing rollers are mounted and configured to apply a biasing force along spaced biasing axes, said biasing axes being substantially perpendicular to said length direction axis.

Preferably said drive rollers are mounted to pivot about pivot axes perpendicular to said length direction axis, each of said pivot axes lying in the reference plane of the respective drive roller.

Preferably when viewed along said length direction axis, contact surfaces of said drive rollers have substantially the same form as those parts of said rail in contact therewith.

Preferably stairlift further includes a levelling facility configured and operable to effect relative rotation between said chair and said carriage as said carriage moves through a bend in said rail in a vertical plane to maintain said chair substantially level.

Preferably said rail includes a bend that, when viewed in plan view, has a bend radius substantially equal to twice the diameter of tubes from which the tail is formed.

Preferably said drive rollers have drive surfaces formed from polyurethane having a shore hardness falling in the range 92 to 95.

Preferably said stairlift, when mounted in a stairway, said rail has an upper end and a lower end, a section of the rail terminating in said lower end being substantially vertical.

Many variations in the way the present invention can be performed will present themselves to those skilled in the art. The description which follows is intended as an illustration only of one means of performing the invention and the lack of description of variants or equivalents should not be regarded as limiting. Subject to the scope of the appended claims, wherever possible, a description of a specific element should be deemed to include any and all equivalents thereof whether in existence now or in the future.

### BRIEF DESCRIPTION OF THE DRAWINGS

The invention will now be described with reference to the accompanying drawings in which:

FIG. 1: shows an isometric view of part of one example of stairlift embodying the invention;

FIG. 2: shows an isometric view, in larger scale, of a base chassis component incorporated in the stairlift carriage shown in FIG. 1;

FIG. 3: shows a part-sectional isometric view, in larger scale, of the carriage and rail shown in FIG. 1;

FIG. 4: shows an isometric view, from the rear, of part of an upper roller sub-assembly incorporated in the carriage of FIG. 3;

FIG. 5: shows a front isometric view of the carriage of FIGS. 3 & 4 illustrating the lower roller sub-assembly;

FIG. 6: shows an isometric view of the carriage configuration when passing through an inside bend;

FIG. 7: shows that which is shown in FIG. 6 from above and with certain parts omitted for clarity;

FIG. 8: shows an isometric view, from above, of the carriage as previously depicted passing through an outside bend;

FIG. 9: shows an elevational view, from the front, of the carriage as previously depicted passing through a negative transition bend;

FIG. 10: shows a similar view to FIG. 9, but from the rear;

FIG. 11: shows a similar view to FIG. 10, but with the carriage passing through a positive transition bend;

FIG. 12: shows an isometric view of part of a second form of stairlift embodying the invention;

FIG. 13: shows a part-sectional view, in a direction along the rail axis, of part of a stairlift carriage shown in FIG. 12;

FIG. 14: shows an isometric view, from the front, of the carriage shown in FIGS. 12 & 13

FIG. 15: shows an elevational view, from the front, of the carriage of FIGS. 12 to 14 passing through a positive transition bend;

FIG. 16: shows a similar view to FIG. 15 but with the carriage passing through a negative transition bend;

FIG. 17: shows an isometric view, from the rear, of the carriage of FIGS. 12 to 16 passing through an outside bend; and

FIG. 18: shows an isometric view, from the rear, of the carriage of FIGS. 15 to 17 passing through an inside bend.

### DETAILED DESCRIPTION OF WORKING EMBODIMENT

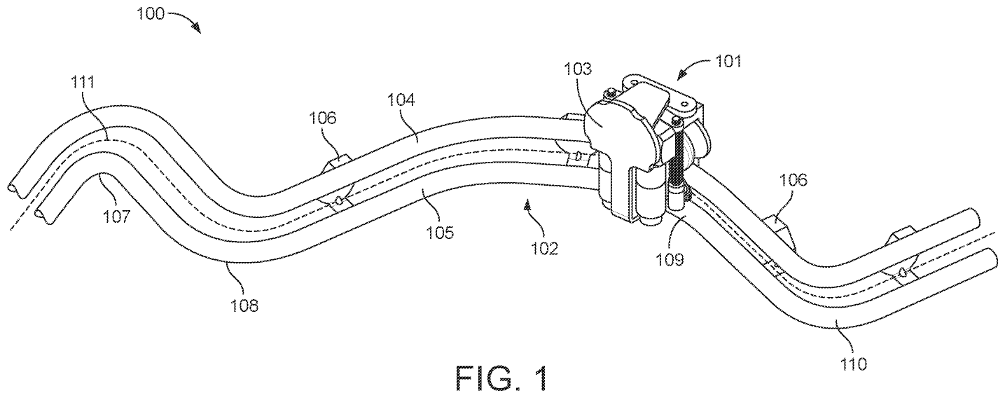

Referring firstly to FIG. 1, a first embodiment of stairlift 100 is shown comprising a carriage 101 mounted on rail 102 for movement along the rail. In the conventional manner the carriage mounts an interface (not shown) via bracket 103, the interface, in turn, mounting a chair (not shown). A levelling facility (not shown) is provided to effect relative rotation between the interface and the carriage so that the chair is maintained substantially level throughout movement of the carriage along the rail. Suitable forms of levelling facility will be well known to those skilled in the art and, not being intrinsic to the invention, will not be further described in this disclosure.

The rail 102 has a drive surface and a surface positioned and configured to resist rotation of the carriage about a lengthwise direction axis of the rail. In this embodiment the drive surface is provided by the upper surface of the rail, in this case the top surface of an upper tube of a rail comprising upper and lower spaced tubes 104 & 105. The surface positioned and configured to resist rotation of the carriage about the lengthwise direction axis of rail is conveniently provided by a lateral surface of the lower tube 105. In the known manner the tubes 104 & 105 are preferably formed from round cross-section metal tube, the tubes being vertically spaced and held at a substantially constant spacing by C-shaped brackets 106. An non-limiting example of suitable tubing is mild steel round section tube having a nominal outside diameter of 45 mm.

As illustrated in FIG. 1, the rail includes a negative transition bend 107, a positive transition bend 108, an outside bend 109 and an inside bend 110. Also shown in FIG. 1 is a length direction axis 111 which follows the direction and angles of the various sections that comprise the rail.

The carriage and rail are configured so that a carriage axis 112 (FIG. 5), which is vertical when the carriage is traversing a horizontal section of rail, is maintained perpendicular to the direction of the rail, or the lengthwise direction axis 111, irrespective of the position of the carriage 103 on the rail 102. This is achieved by arranging the rail tubes 104 and 105 at a substantially constant vertical spacing, and by a configuration of drive rollers and biasing means that will be described in greater detail below.

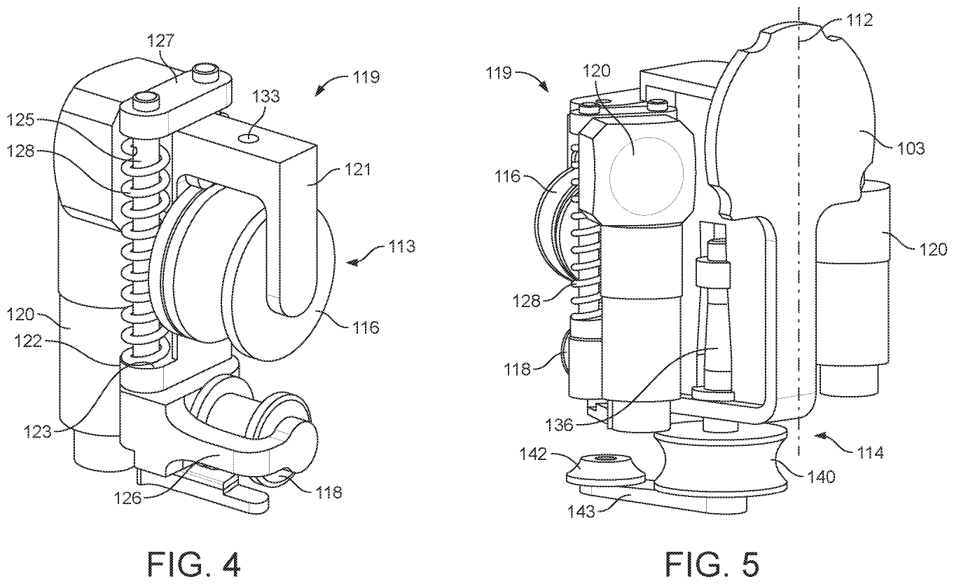

In this embodiment the carriage 101 includes a drive roller assembly 113 which is configured to frictionally engage with the upper rail tube 104, and more particularly, the drive surface comprised in the upper surface of the upper rail tube 104. As shown the drive roller assembly 113 comprises a pair of friction rollers 116 that engage spaced points on the drive surface; and biasing means, in this case a pair of biasing rollers 118 that engage an under-surface of the upper rail tube 104, and that are configured, mounted and positioned to bias the friction rollers 116 into contact with the upper rail tube 104. The drive and biasing rollers are preferably provided in sets, one of the sets 119 being shown in FIG. 4. Each set 119, in this embodiment, further includes a drive motor/gearbox unit 120 to impart drive to the drive roller 116. Each drive roller 116 is mounted for rotation in a bracket 121 that includes laterally extending projections 122 on either side, the projections 122 including bores 123 to receive shafts 125 extending, parallel to the carriage axis 112, upwardly from a bracket 126 in which the biasing roller 118 is rotatably mounted. An upper cross member 127 is fixed to the upper ends of the shafts 125 and biasing components such as coil springs 128 are conveniently located around the shafts 125 and act between the projections 122 and the cross member 127 to displace the biasing rollers 118 toward their respective drive rollers 116. Those skilled in the art will, however, appreciate that other means could be provided to apply the bias including pneumatic and/or hydraulic arrangements.

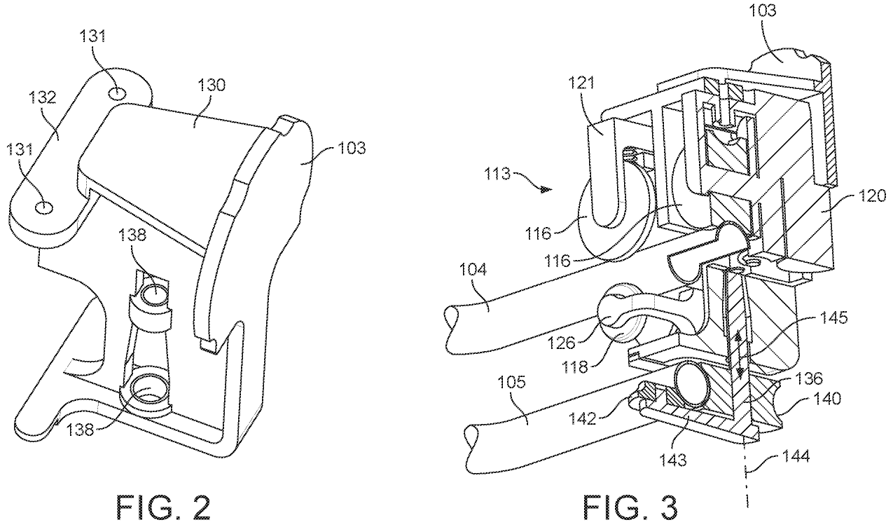

Two roller sets 119 are mounted to a chassis base member 130 that is illustrated in FIG. 2. Pins or the like (not shown) pass through spaced mounting apertures 131 in the chassis cross member 132 and engage in mounting apertures 133 in the drive roller brackets 121. This allows the respective roller sets 119 to pivot about mounting axes 134 as shown in FIG. 7. When the carriage is assembled on to the rail, the axes 134 pass through the vertical centreline of the upper rail tube 104 and are parallel to carriage axis 112.

The second roller assembly 114 preferably comprises a pair of rollers that engage the lower rail tube 105 on opposite sides of a vertical axis passing through the centreline of the tube 105. As shown, the roller assembly 114 is mounted on a shaft 136 aligned parallel to the carriage axis 112, the shaft 136 being located within bores 138 in the chassis base. The pair of rollers comprise a main reaction roller 140, which can freely rotate on a fixed axis defined by shaft 136, and a locating roller 142 which is rotatably mounted on arm 143 projecting from the lower end of shaft, such that the arm can pivot about shaft axis 144. The shaft 136 can also rise and fall within the chassis base as shown by arrow 145 in FIG. 3. This allows the carriage, while traveling along the rail, to accommodate any changes in the spacing of rail tubes 104 & 105 such as typically arises in transition bends; and may also arise from variations in manufacturing tolerances. It can be seen that, when the carriage is viewed in front or rear elevation, the shaft axis 144 is positioned mid-way between the axes 133.

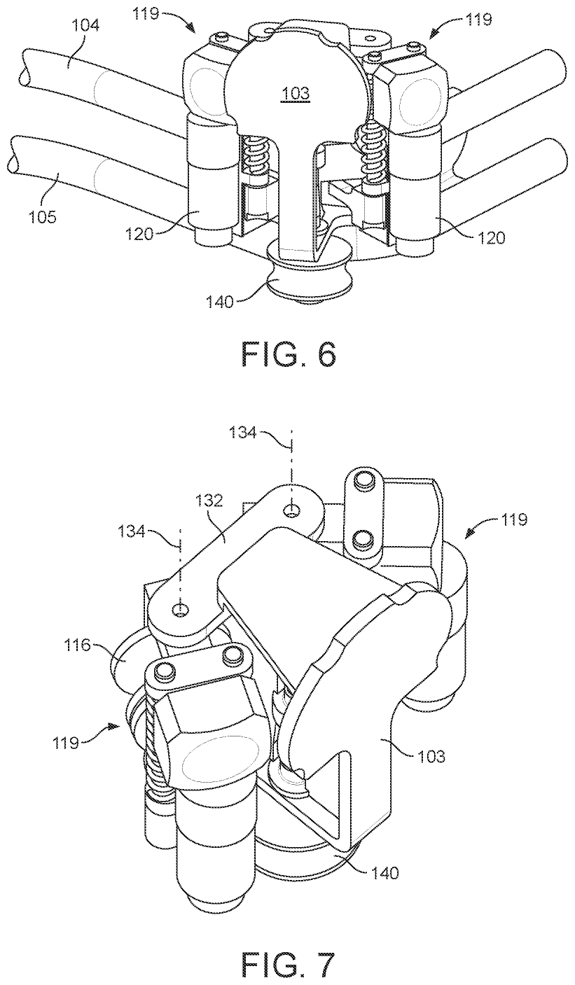

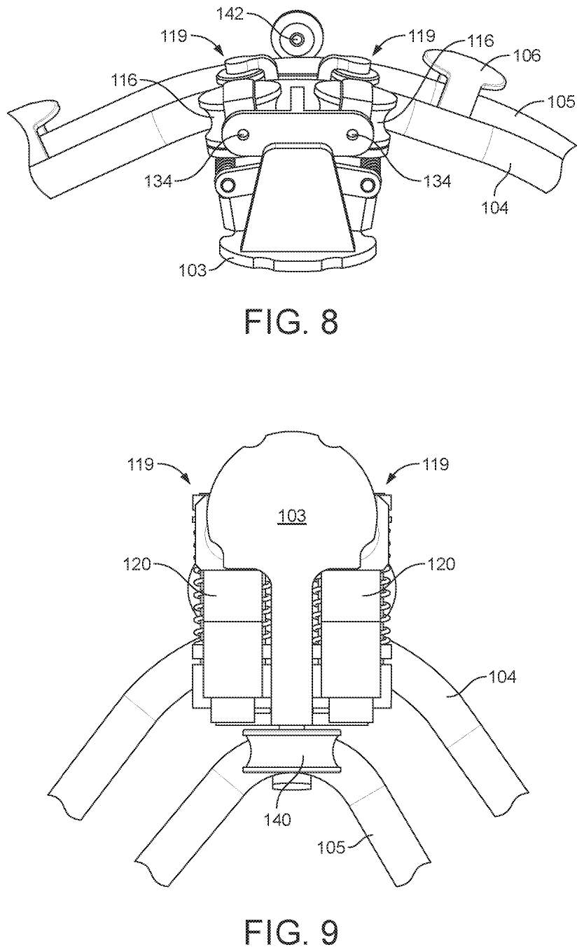

FIG. 8 shows the behaviour of the roller assemblies when passing through an outside bend. As can be seen, the roller sets 119 of the upper roller assembly pivot about axes 134 in first but opposite senses. In FIGS. 6 and 7 the roller sets are shown in an inside bend and, as can be seen, the roller pairs 119 again pivot about axes 134, but in second, opposite senses. It will also be appreciated that, in both inside bends and outside bends, the arm 143 on which the location roller 142 is mounted can pivot about axis 144 to maintain both the reaction roller and location roller in contact with the lower rail tube 105.

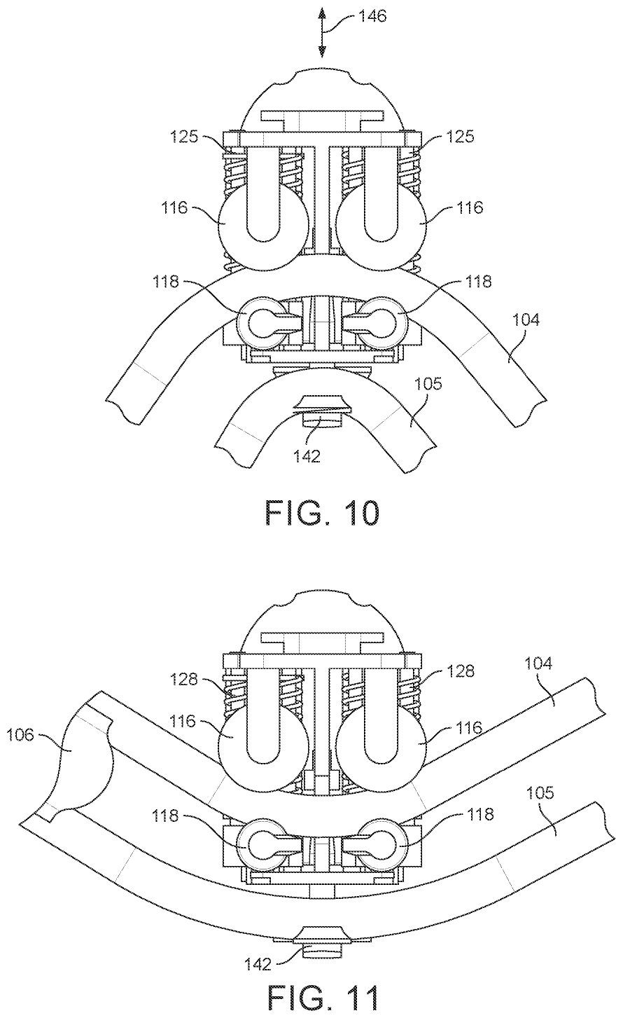

FIGS. 9 & 10 show, from the front and rear respectively, the behaviour of the roller sets when passing through a negative transition bend while FIG. 11 shows, from the rear, the behaviour of the roller sets when passing through a positive transition bend. When passing through both types of transition bend, the biasing rollers 118 displace with respect to the drive rollers 116, in a direction parallel to the carriage axis 112 as indicated by arrow 146 in FIG. 10, the shafts 125 sliding in bores 123 against the bias of springs 128. The second or lower roller set can also move in the direction of arrow 145 in FIG. 3 to accommodate any changes in rail spacing in the transition bends.

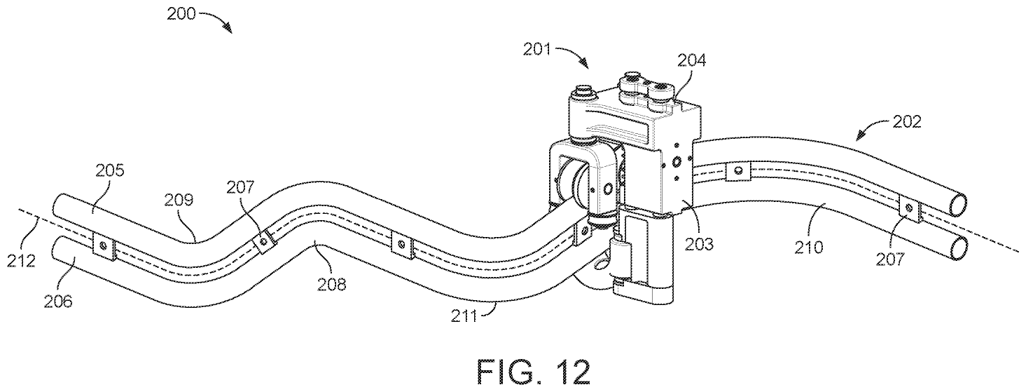

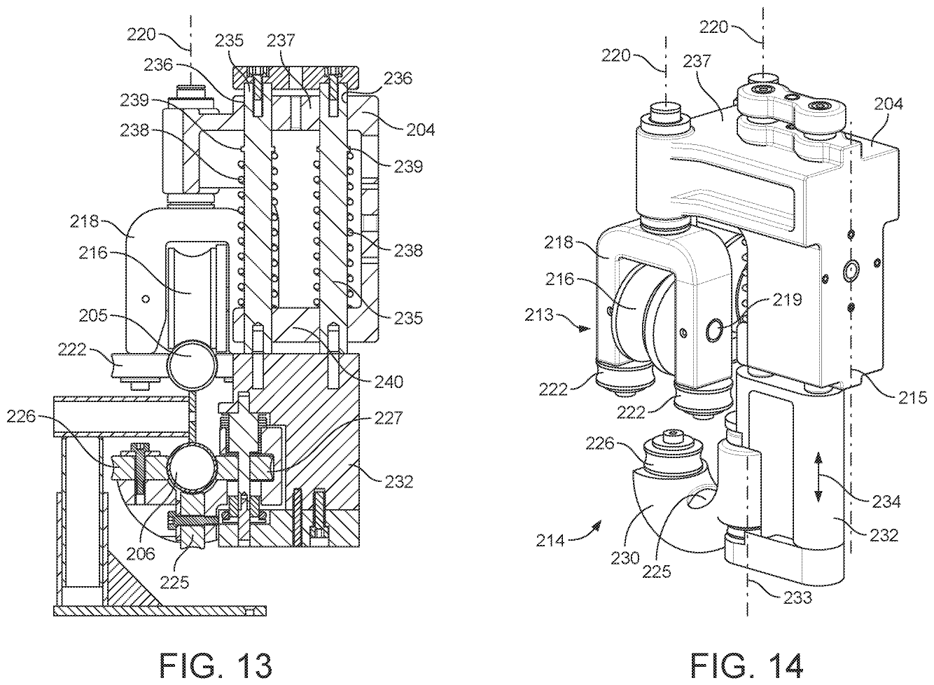

Turning now to FIGS. 12 to 18, a second example of stairlift 200 embodying the invention is depicted. As shown in FIG. 12, the stairlift 200 comprises a carriage 201 mounted on rail 202 for movement along the rail. In the conventional manner the carriage mounts an interface (not shown) on the front face 203 of carriage chassis 204, the interface, in turn, mounting a chair (not shown). A levelling facility (not shown) is provided to effect relative rotation between the interface and the carriage so that the chair is maintained substantially level throughout movement of the carriage along the rail. As stated above, the levelling facility is not intrinsic to the invention, will not be further described in this disclosure.

As with the embodiment previously described, the rail 202 has a drive surface and a surface positioned and configured to resist rotation about a lengthwise direction axis of the rail. As with the previous embodiment the drive surface is defined by a top surface of upper rail tube 205 while the reaction surface is preferably provided by a lateral surface of lower rail tube 206. The rail tubes 205 & 206 are preferably vertically spaced and held at a substantially constant vertical spacing by brackets 207 which are preferably aligned along, or substantially along, the vertical centrelines of the rail tubes 205 & 206.

As illustrated, the rail includes a negative transition bend 208, a positive transition bend 209, an outside bend 210 and an inside bend 211. Also shown is a length direction axis 212 which follows the direction and angles of the various sections that comprise the rail 202.

The carriage is configured so that a carriage axis 215 (FIG. 14), which is vertical when the carriage is traversing a horizontal section of rail, is maintained substantially perpendicular to the direction of the rail, or length direction axis 212, irrespective of the position of the carriage 203 on the rail 202. This is achieved by the constant spacing of rail tubes, and by providing the carriage with a first or upper roller set 213 that engages with the upper rail 205 and a biasing arrangement 214 that engages with the lower rail 206 and operates to draw the upper roller set into engagement with the drive surface on the upper rail 205.

In this embodiment the first roller assembly 213 is configured as the drive roller set and is further configured to frictionally engage with spaced points on an upper surface part of upper rail tube 205. As shown the upper roller assembly 213 comprises a pair of friction drive rollers 216 mounted in inverted U-shaped brackets 218 to rotate about axes 219. The brackets 218 are mounted to the chassis base 204 to pivot about spaced axes 220, the axes 220 being parallel to carriage axis 212 and passing through the vertical centreline of upper rail tube 205. Motor/gearbox units (not shown) are preferably mounted on the brackets 218 to impart drive to the rollers 216 and the brackets further mount support rollers 222 on the free ends of the U-arms, the rollers 222 serving to maintain the drive rollers 216 in correct alignment with the upper rail tube 205, and to resist lateral loading on the rollers 216.

In the first embodiment described above both the drive rollers, and the biasing facility required to maintain engagement of the drive rollers against the rail, engage the top rail tube. In this second embodiment the drive rollers, as before, drive against the upper rail tube 205 while the biasing force is applied against the lower tube 206. The biasing facility, in this embodiment, is conveniently provided by a second or lower roller assembly 214 comprising a biasing roller 225 configured and positioned to apply an upward biasing force along the vertical centreline of lower rail tube 206. The assembly 214 further comprises a pair of locating rollers 226 & 227 positioned to engage the lower rail tube 206 on opposite sides of a vertical centreline passing through the tube 206 and configured to resist lateral movement of the roller set 214 in a direction along or substantially along the horizontal centreline of the lower rail tube 206.

The rollers 225, 226 & 227 are mounted in a cradle 230 the cradle, in turn, being mounted on lower bracket 232 for pivotal movement about axis 233; axis 233 being parallel to carriage axis 215. Roller 227 rotates about axis 233 while roller 226 is rotatably mounted to the cradle at a position spaced from axis 233, cradle 230 effective comprising an arm pivotal about axis 233.

The lower bracket 232 is mounted on the carriage chassis 204 for sliding movement in the direction of arrow 234 (FIG. 14). Again, movement in the direction of arrow 234 is also parallel to the carriage axis 215 and the axis of movement is substantially mid-way between the axes 220. In the form shown, two pillars 235 extend upwardly from the lower bracket 232 and are slidably received in bores 236 formed in an upper face 237 of the carriage chassis 204. Compression springs 238 are preferably provided, mounted about pillars 235 and acting between circlips 239 mounted in the pillars and base 240 of the carriage chassis 204 to bias the biasing roller 225 vertically upward against the lower rail tube 206.

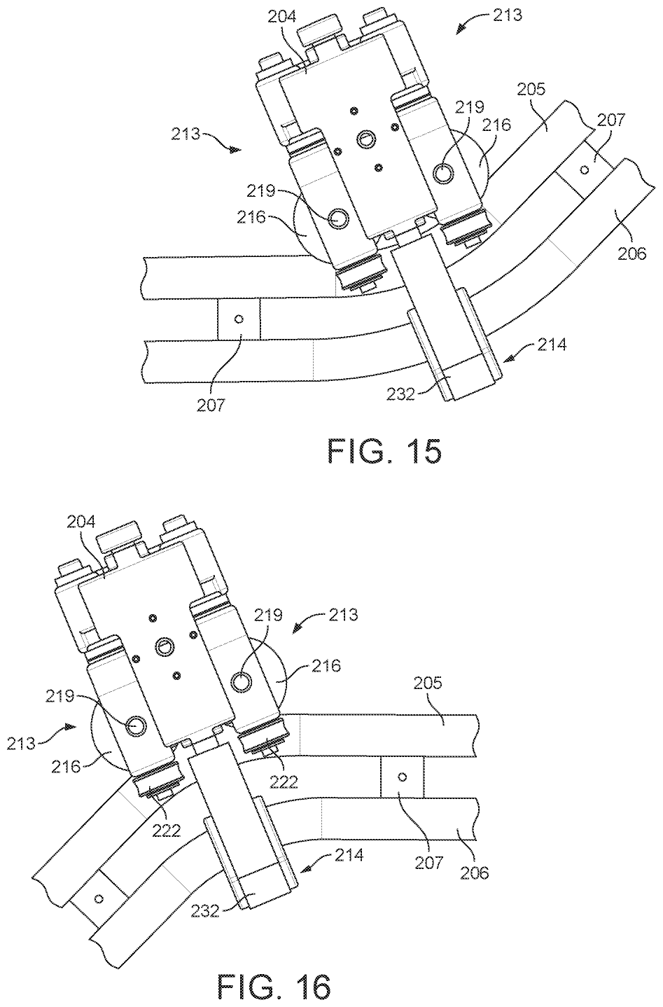

FIGS. 15 and 16 show respectively, from the front, the behaviour of the roller assemblies 213 & 214 when passing through positive and negative transition bends. When passing through both types of transition bend, the lower roller assembly 214 displaces with respect to the upper roller assembly in a direction parallel to the carriage axis 212 as indicated by arrow 234, against the bias of compression springs 238. This not only allows the carriage to pass through transition bends but also accommodates any variation in spacing of the rail tubes, whether or not the variation occurs in a transition bends. Indeed, while the spacing between the rail tubes is substantially constant, some variations may be deliberately introduced so that the biasing force applied by the lower roller assembly is maintained substantially constant.

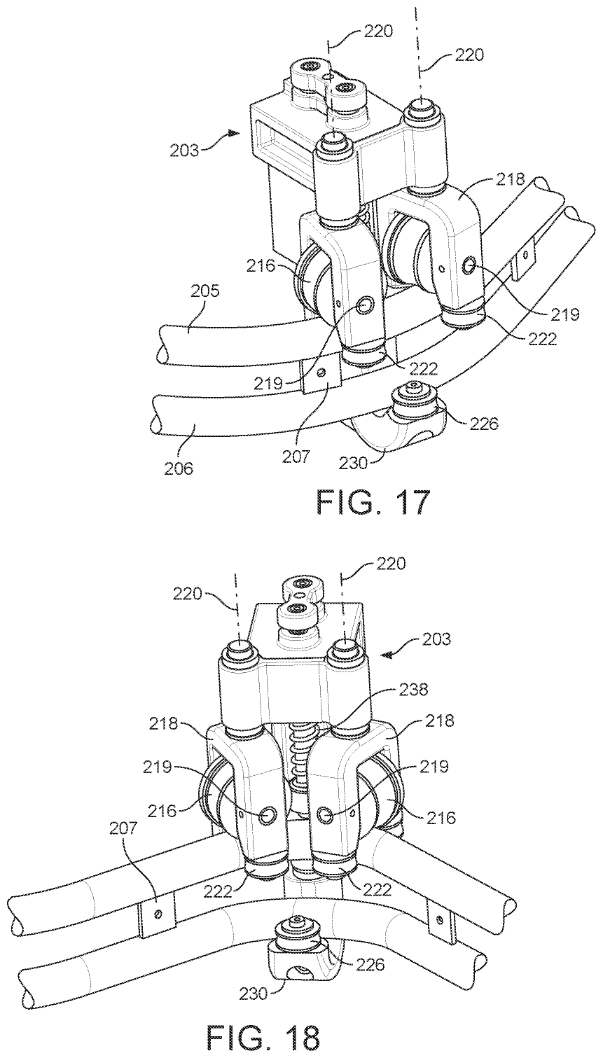

FIG. 17 shows the behaviour of the roller assemblies, from the rear, when passing through an outside bend. As can be seen, the drive rollers 216 pivot about axes 220 in first, opposite senses to accommodate the bend. In FIG. 18 the behaviour in shown, from the rear, of the rollers 216 in an inside bend and, as can be seen, the rollers again pivot about axes 220 but, in second opposite senses to that shown in FIG. 17. It can further be seen that in both inside bends and outside bends, the cradle 230 on which the lower roller set 214 is mounted can pivot about axis 233 to maintain the lower roller assembly 20 in contact with the lower rail tube 206.

In both of the described embodiments the drive rollers are preferably formed from a high friction plastics material such as, for example, polyurethane although this is not essential and any suitable material may be used. We have found that polyurethane drive rollers having a shore hardness lying in the range 92-95 are particularly suitable. Materials of less hardness may be used to provide greater friction at the cost of greater rates of wear. Similarly, materials of greater hardness will exhibit less wear but offer less friction.

The use of two small friction drive wheels typically, but not confined to, diameters at the core of 75-100 mm results in a stairlift that exhibits improved ride quality over rack and pinion drive systems but also allows tighter bends and steeper rail angles to be accommodated. Depending on the geometry of the carriage, it is envisaged that inside bends of substantially 2× the nominal tube diameter can be achieved, meaning inside bends of 90-100 mm radius, formed from tube of nominal diameter 45 mm, can be accommodated. This, in turn, allows improved rail to stair fit.

1. A stairlift including a rail having a top surface and a length direction axis extending parallel to said top surface;
a carriage mounted on said rail for movement there-along, said carriage and said rail being configured such that the carriage is substantially perpendicular to the length direction axis at any position of the carriage on the rail; and a chair mounted on said carriage, wherein:
said top surface defines a drive surface extending along said rail, said carriage including a plurality of drive rollers configured and arranged to frictionally engage said drive surface at spaced positions on said drive surface, a reference plane passing through the centre of each drive roller, perpendicular to the axis of rotation of the respective drive roller, passing through a centreline of the rail at any position of the carriage on the rail, said carriage further including biasing means to apply a clamping bias effective to clamp said drive rollers against said rail; and means to resist rotational movement of said carriage about said length direction axis.

2. The stairlift as claimed in claim 1 wherein said drive surface is defined by a first lengthwise extending member and said means to resist rotational movement of said carriage about said length direction axis is defined in part by a second lengthwise extending reaction surface and wherein, when said rail is in its position of use, said reaction surface is spaced from and below said drive surface.

3. The stairlift as claimed in claim 2 wherein said first and second lengthwise extending members comprise two substantially evenly spaced tubes of round cross-section which, when the rail is mounted for use, are arranged substantially above one another

4. The stairlift as claimed in claim 3 wherein the drive rollers engage an upper tube of said two spaced tubes, said biasing means including one or more biasing rollers engaging an underside of said upper tube.

5. The stairlift as claimed in claim 3 wherein the drive rollers engage an upper tube of said two spaced tubes, said biasing means including one or more biasing rollers engaging a lower tube of said two spaced tubes.

6. The stairlift as claimed in claim 5 wherein said biasing rollers partly define said means to resist rotation of the carriage about said length direction axis.

7. The stairlift as claimed in claim 3 wherein said means to resist rotational movement of said carriage about said length direction axis includes a plurality of support rollers engaging a lower tube of said two spaced tubes.

8. The stairlift as claimed in claim 7 wherein said plurality of support rollers comprise two rollers engaging said lower tube on opposite sides of a vertical centreline of said lower tube.

9. The stairlift as claimed in claim 8 wherein said two rollers comprise a first roller rotatable about a fixed axis; and a second roller rotatably mounted on an arm, the arm being mounted to pivot about said fixed axis.

10. The stairlift as claimed in claim 4 wherein said biasing rollers are mounted and configured to apply a biasing force along spaced biasing axes, said biasing axes being substantially perpendicular to said length direction axis.

11. The stairlift as claimed in claim 1 wherein said drive rollers are mounted to pivot about pivot axes perpendicular to said length direction axis, each of said pivot axes lying in the reference plane of the respective drive roller.

12. The stairlift as claimed in claim 1 wherein, when viewed along said length direction axis, contact surfaces of said drive rollers have substantially the same form as those parts of said rail in contact therewith.

13. The stairlift as claimed in claim 1 further including a levelling facility configured and operable to effect relative rotation between said chair and said carriage as said carriage moves through a bend in said rail in a vertical plane to maintain said chair substantially level.

14. The stairlift as claimed in claim 1 wherein said rail includes a bend having a radius substantially equal to twice the diameter of tubes from which the tail is formed.

15. The stairlift as claimed in claim 1 wherein said drive rollers have drive surfaces formed from polyurethane having a shore hardness falling in the range 92 to 95.

16. The stairlift as claimed in claim 1 wherein, when mounted in a stairway, said rail has an upper end and a lower end, a section of the rail terminating in said lower end being substantially vertical.
